(19) United States
(12) Patent Application Publication
(10) Pub. No.: US 2003/0083411 A1
(43) Pub. Date: May 1, 2003

(54) Charging member

(75) Inventors: Hiroki Sugiura, Komaki-shi (JP); Tetsuya Itoh, Komaki-shi (JP); Koji Yamaguchi, Mizunami-shi (JP); Kenichi Tsuchiya, Komaki-shi (JP); Jiro Iwashiro, Kasugai-shi (JP)

Correspondence Address: ARMSTRONG,WESTERMAN & HATTORI, LLP, 1725 K STREET, NW., SUITE 1000, WASHINGTON, DC, 20006, US

(73) Assignee: Tokai Rubber Industries, Ltd., Komaki-shi (JP)

(21) Appl. No.: 10/178,393

(22) Filed: Jun. 25, 2002

(30) Foreign Application Priority Data
Jun. 26, 2001 (JP) JP2001-193613

(51) Int. Cl. C08K 5/32

(52) U.S. Cl. 524/260

(57) ABSTRACT

A charging member which is composed of a material containing a smaller amount of an ionic electrically conductive agent, and yet has a reduced resistivity and, when being energized, is less susceptible to an increase in electrical resistance, thereby assuredly preventing an imaging failure. The charging member comprises a base material and an ionic electrically conductive agent of a quaternary ammonium salt represented by the following general formula (1):

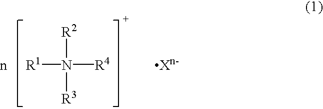

wherein R¹ to R⁴ are alkyl groups, at least one of which is a C₄₋₈ alkyl group and at least one of which is different from the at least one C₄₋₈ alkyl group, Xⁿ⁻is an n-valent anion, and n is an integer of 1 to 6.

### BACKGROUND OF THE INVENTION

1. Field of the Invention

The present invention relates to a charging member for use as a charging roll, a charging blade or the like in an electrophotographic apparatus such as a copying machine, a printer or a facsimile machine.

2. Description of the Art

In electrophotographic copying machines, copying operations are performed by forming an electrostatic latent image corresponding to an original image on the surface of a photoreceptor drum, developing the electrostatic latent image with a toner to form a toner image, and transferring the toner image onto a copy sheet. For the formation of the electrostatic latent image, the surface of the photoreceptor drum is preliminarily electrically charged, and irradiated with light by an optical system which projects the original image. Thus, electric charges on an irradiated surface portion of the photoreceptor drum are dissipated, whereby the electrostatic latent image is formed on the surface of the photoreceptor drum.

The copying operation will be described in greater detail with reference to FIG. 4, in which an exemplary electrophotographic copying machine is shown. In operation of the machine, a charging roll 2 is rotated in contact with the outer circumferential surface of a photoreceptor drum 1 which is rotated in the direction of the arrow about its axis 1a, and a voltage is applied to the charging roll to electrically charge the outer circumferential surface of the photoreceptor drum. A slit light beam 8 of a light image of a document original is incident on the surface of the photoreceptor drum 1 through an exposure mechanism 3, whereby an electrostatic latent image corresponding to the original image is formed on the surface of the photoreceptor drum 1. A developing unit 4 causes a toner to adhere onto the electrostatic latent image to form a toner image. In turn, a transfer roll 5 transfers the toner image on a copy sheet 11 fed to the surface of the photoreceptor drum 1 by sheet feeder rolls 6. The copy sheet 11 formed with the toner image is passed between fixing rolls 7, whereby the toner image is fixed on the copy sheet 11. Thus, a copy of the image is obtained. Thereafter, the surface of the photoreceptor drum 1 is cleaned by a cleaner 9 for removal of an image residue and residual toner, and irradiated by an eraser lamp 10 for removal of electric charges so as to be ready for the next electrical charging. In FIG. 4, reference numeral 12 denotes a power source for applying a voltage of about 1 kV to about 3 kV to the charging roll 2.

Conventionally employed as a material for the charging roll 2 (charging member) is an electrically conductive material prepared by including 0.001 to 10 parts by weight (hereinafter abbreviated to “parts”) of a quaternary ammonium salt represented by the following general formula (A) as an ionic electrically conductive agent in a polymer component such as an epichlorohydrin-ethylene oxide copolymer rubber, an acrylonitrile-butadiene rubber or a urethane rubber. The inclusion of the quaternary ammonium salt ensures that the volume resistivity of the electrically conductive material is stably maintained in a range from 10⁵ Ω·cm to 10⁹ Ω·cm with a high level of accuracy. Therefore, variations in the volume resistivity and surface resistivity of the charging member due to a change in ambient temperature can be reduced. General formula (A) is as follows:

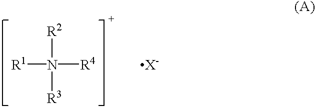

wherein R¹ to R⁴ are alkyl groups, and X⁻is a monovalent anion.

Even if the amount of the conventional ionic electrically conductive agent is increased, there is a limit to the reduction in electrical resistance. When a larger amount of the ionic electrically conductive agent is included in the material for the reduction in electrical resistance, the ionic electrically conductive agent may bleed out under high-temperature and high-humidity conditions. When the charging roll is energized, the electrical resistance of the charging roll is drastically increased, and the charging performance of the charging roll is deteriorated with time. This results in an imaging failure.

In addition, the ionic electrically conductive agent imparts the material with a poor electrical conductivity and a poor electrical durability, thereby adversely influencing the performance of the charging roll.

In view of the foregoing, it is an object of the present invention to provide a charging member which is composed of a material containing a smaller amount of an ionic electrically conductive agent, and yet has a reduced resistivity and, when being energized, is less susceptible to an increase in electrical resistance, thereby assuredly preventing an imaging failure.

### SUMMARY OF THE INVENTION

To achieve the aforesaid object, among others, there is provided a charging member comprising a base material and an ionic electrically conductive agent of a quaternary ammonium salt represented by the following general formula (1):

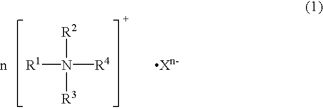

wherein R¹ to R⁴ are alkyl groups, at least one of which is a C₄₋₈ alkyl group and at least one of which is different from the at least one C₄₋₈ alkyl group, Xⁿ⁻is an n-valent anion, and n is an integer of 1 to 6.

The inventors of the present invention conducted intensive studies on ionic electrically conductive agents of a quaternary ammonium salt to provide a material for a charging member having an electrical resistance adjusted at a level lower than a conventional level by inclusion of a smaller amount of the ionic electrically conductive agent. Particularly, the studies were focused on four substituent groups bonded to the nitrogen (N) atom of the quaternary ammonium salt. The inventors initially expected that, where all the substituent groups are alkyl groups, the quaternary ammonium salt would advantageously serve for the purpose, but found that not all combinations of alkyl groups are advantageous. The inventors conducted further studies on preferred combinations of alkyl groups as the substituent groups and finally found that, where at least one of the four alkyl groups is different from the other alkyl groups and at least one of the four alkyl groups is a C₄₋₈ alkyl group, the nitrogen atom at the center of the cation moiety has a greater charge amount. Thus, the present invention has been attained.

For example, when one of R¹ to R⁴ in the general formula (1) representing the quaternary ammonium salt is a C₄-, C₆- or C₈-alkyl group and the other three of R¹ to R⁴ are each a methyl group or an ethyl group, the charge amount of the nitrogen atom can advantageously be increased.

As another example, when three of R¹ to R⁴ in the general formula (1) representing the quaternary ammonium salt are each a C₄-, C₆- or C₈-alkyl group, and the other of R¹ to R⁴ is a methyl group or an ethyl group, the charge amount of the nitrogen atom can advantageously be increased.

Further, when the quaternary ammonium salt represented by the general formula (1) is present in a predetermined proportion, the electrical resistance of the charging member can easily be reduced to a desired level, and bleed-out of the quaternary ammonium salt can be more effectively suppressed.

### BRIEF DESCRIPTION OF THE DRAWINGS

FIG. 1 is a diagram illustrating an exemplary method for producing a charging roll;

FIG. 2 is a perspective view illustrating, partly in section, the construction of a charging roll as an example of a charging member according to the present invention;

FIG. 3 is a sectional view illustrating the construction of the charging roll of FIG. 2;

FIG. 4 is an explanatory diagram schematically illustrating the construction of an electrophotographic copying machine; and

FIG. 5 is a diagram for explaining how to measure the electrical resistance of the charging roll.

### DESCRIPTION OF THE PREFERRED EMBODIMENTS

The present invention will hereinafter be described in detail by way of embodiments thereof.

A charging member according to the present invention is composed of a material containing a base material and an ionic electrically conductive agent of a quaternary ammonium salt represented by the following general formula (1):

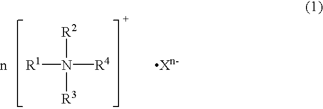

wherein R¹ to R⁴ are alkyl groups, at least one of which is a C₄₋₈ alkyl group and at least one of which is different from the at least one C₄₋₈ alkyl group, Xⁿ⁻is an n-valent anion, and n is an integer of 1 to 6.

A notable feature of the present invention is to employ the quaternary ammonium salt represented by the general formula (1) in which at least one of the alkyl groups R¹ to R⁴ is different from the other alkyl groups and at least one of the alkyl groups R¹ to R⁴ is a C₄₋₈ alkyl group. It is particularly preferred that one of R¹ to R⁴ is a C₄-, C₆- or C₈-alkyl group, or three of R¹ to R⁴ are each a C₄-, C₆- or C₈-alkyl group.

The C₄₋₈ alkyl group may be linear, branched or cyclic, but is preferably linear in consideration of intra-molecular steric hindrance. Specifically, the C₄-, C₆- and C₈-alkyl groups are preferably butyl, hexyl and octyl groups, respectively.

The other alkyl groups (alkyl groups other than the C₄₋₈ alkyl group) represented by R¹ to R⁴in the general formula (1) are not particularly limited, but preferably each have a smaller number of carbon atoms than the C₄₋₈ alkyl group and may be linear, branched or cyclic.

When one of R¹ to R⁴ is a C₄-alkyl group, the other three of R¹ to R⁴ each may be an alkyl group having three or less carbon atoms, and preferred examples thereof include methyl, ethyl and propyl groups. When one of R¹ to R⁴ is a C₈-alkyl group, the other three of R¹ to R⁴ each may be an alkyl group having seven or less carbon atoms, and preferred examples thereof include methyl, ethyl, propyl, butyl, pentyl, hexyl and heptyl groups.

When three of R¹ to R⁴ are each a C₄-alkyl group, the other of R¹ to R⁴ may be an alkyl group having three or less carbon atoms, and preferred examples thereof include methyl, ethyl and propyl groups. When three of R¹ to R⁴ are each a C₈-alkyl group, the other of R¹ to R⁴ may be an alkyl group having seven or less carbon atoms, and preferred examples thereof include methyl, ethyl, propyl, butyl, pentyl, hexyl and heptyl groups.

The n-valent anion Xⁿ⁻in the general formula (1) is not particularly limited, but examples thereof include halogen ions such as F⁻, Cl⁻, Br⁻and I⁻as well as the anions ClO₄⁻, BF₄⁻, SO₄²⁻, HSO₄⁻, CH₃SO₄⁻, C₂H₅SO₄⁻, CH₃SO₃⁻, C₂H₅SO₃⁻and COOH⁻, among which Br⁻, I⁻, ClO₄⁻, HSO₄⁻and C₂H₅SO₄⁻are preferred for reduction in the electrical resistance of the charging member.

The integer n in the general formula (1) is 1 to 6, preferably 1 to 4, more preferably 1 or 2.

A quaternary ammonium salt represented by the following general formula (2A) is advantageously employed as the quaternary ammonium salt represented by the general formula (1). Methyl groups in the general formula (2A) may be substituted by ethyl groups.

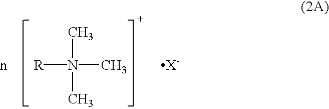

wherein R is a C₄-, C₆- or C₈-alkyl group, Xⁿ⁻is an n-valent anion, and n is an integer of 1 to 6.

When one of the four alkyl groups bonded to the nitrogen atom is a C₄-, C₆- or C₈-alkyl group and the other three alkyl groups are methyl or ethyl groups as in the general formula (2A), the nitrogen atom advantageously has a greater charge amount.

A quaternary ammonium salt represented by the following general formula (2B) is also advantageously employed. Methyl groups in the general formula (2B) may be substituted by ethyl groups.

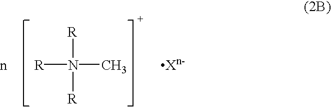

wherein R is a C₄-, C6- or C₈-alkyl group, X^{n -}is an n-valent anion, and n is an integer of 1 to 6.

When three of the four alkyl groups bonded to the nitrogen atom are each a C₄-, C₆- or C₈-alkyl group and the other alkyl group is a methyl or ethyl group as in the general formula (2B), the nitrogen atom advantageously has a greater charge amount.

The base material contained in the material for the inventive charging member is not particularly limited, but may be a polar polymer having a polarity. Examples of the polar polymer include epichlorohydrin rubbers (CO), epichlorohydrin-ethylene oxide copolymer rubbers (ECO), acrylonitrile-butadiene rubbers (NBR), urethane rubbers, chloroprene rubbers, chlorosulfonated polyethylene rubbers, ethylene oxide-propylene oxide copolymers, ethylene oxide-propylene oxide-allyl glycidyl ether copolymers, and epichlorohydrin-ethylene oxide-allyl glycidyl ether copolymers, which may be used either alone or in combination. Among these polar polymers, ECO, NBR and urethane rubbers are preferred because of their low electrical resistances.

The quaternary ammonium salt of the general formula (1) is preferably present in the material in a proportion of 0.05 to 5 parts, more preferably 0.5 to 3 parts, based on 100 parts of the polar polymer. If the proportion of the quaternary ammonium salt is smaller than 0.05 parts, it may be difficult to reduce the electrical resistance of the charging member to a predetermined level. If the proportion of the quaternary ammonium salt is greater than 5 parts, the quaternary ammonium salt tends to be liable to bloom to the surface of the charging member with a poor compatibility with the polar polymer.

As required, a cross-linking agent, a cross-linking accelerator, a processing agent, an anti-aging agent, a softener and a reinforcing material may be included in the material for the inventive charging member.

Further, an electron conductive agent may be included in combination with the quaternary ammonium salt to the material for the inventive charging member. Examples of suitable electron conductive agents include powdery metals such as aluminum power and stainless steel powder, electrically conductive metal oxides such as c-ZnO, c-TiO₂, c-Fe₃O₄ and c-SnO₂, and powdery electrically conductive agents such as graphite and carbon black, which may be used either alone or in combination. The prefix “c-” means that the prefixed substances are electrically conductive.

Next, an explanation will be given to a charging roll as an example of the charging member composed of the aforesaid material.

For example, the charging roll may include a shaft, an electrically conductive elastic layer provided around the shaft, and a resistance adjusting layer provided on the outer circumferential surface of the electrically conductive elastic layer.

The shaft is not particularly limited, but may be a solid cylindrical metal shaft or a hollow cylindrical metal shaft.

The electrically conductive elastic layer provided around the shaft is composed of an elastic material or a foamed material. Examples of the material for the electrically conductive elastic layer include synthetic rubbers such as polynorbornene rubbers, ethylene-propylene-diene rubbers (EPDM) and styrene-butadiene rubbers, which may be used either alone or in combination. The electrically conductive elastic layer typically has a conductivity of about 10¹ Ω·cm to about 10⁵ Ω·cm. The electrically conductive elastic layer typically has a thickness of about 1 mm to about 10 mm, preferably about 2 mm to about 4 mm.

The electrically conductive elastic layer preferably has a hardness (JIS A) of not greater than 25 (Hs). With such a hardness, imaging failures such as transversely inconsistent image density and fogging tends to be prevented, which may otherwise occur due to minute vibrations of the charging roll in contact with the photoreceptor drum when the charging roll is incorporated in the electrophotographic copying machine such as shown in FIG. 4. The hardness of the electrically conductive elastic layer may be adjusted to the predetermined level by adding a softener such as oil to the elastic layer material. A preferred example of the softener is a naphthenic oil. As required, carbon black such as Ketjen Black may be added as an electrically conductive agent to the elastic layer material.

The resistance adjusting layer provided on the outer circumferential surface of the electrically conductive elastic layer is composed of the material for the inventive charging member described above, i.e., the material containing the aforesaid quaternary ammonium salt. The resistance adjusting layer typically has a thickness of 10 μm to 1,000 μm, preferably 80 μm to 700 μm.

It is particularly preferred that the charging roll further includes a protective layer provided on the outer circumferential surface of the resistance adjusting layer. As required, a softener migration preventing layer may be provided between the electrically conductive elastic layer and the resistance adjusting layer.

More particularly, the protective layer provided as an outermost layer on the outer circumferential surface of the resistance adjusting layer may be composed of a conventionally known material such as an N-methoxymethylated nylon, a fluororesin, a urethane resin or an acryl resin. An electrically conductive agent such as carbon black is preferably dispersed in the protective layer. Thus, the charging roll has a proper conductivity even under low-temperature and low-humidity conditions so as to ensure good performance. The protective layer preferably has a thickness of 1 μm to 25 μm, more preferably 3 μm to 20 μm. The protective layer typically has an electrical resistance of 10⁷ Ω·cm to 10¹¹ Ω·cm. The electrically conductive agent which may be dispersed in the protective layer is not limited to carbon black, but a conventionally known electrically conductive agent may be employed instead of carbon black.

The softener migration preventing layer optionally provided between the electrically conductive elastic layer and the resistance adjusting layer prevents the softener (oil) from bleeding out of the electrically conductive elastic layer. The softener migration preventing layer is composed of a conventionally known material such as an N-methoxymethylated nylon. The softener migration preventing layer typically has a thickness of 1 μm to 20 μm, preferably 3 μm to 10 μm. The softener migration preventing layer has an electrical resistance of not greater than 10⁵ Ω·cm. The softener migration preventing layer preferably contains a conventionally known electrically conductive agent such as carbon black.

The charging roll according to the invention may be produced in the following manner. An adhesive is applied on the outer circumferential surface of a metal shaft, and an electrically conductive elastic layer is formed around the metal shaft by vulcanizing the electrically conductive elastic layer material (rubber composition) in a mold. As required, the surface of the electrically conductive elastic layer is polished. Then, a softener migration preventing layer, a resistance adjusting layer and a protective layer are formed in this order on the electrically conductive elastic layer by performing a spraying/dipping and drying process and, as required, a heat treatment. As an alternative manner, a metal shaft with an adhesive applied on the outer circumferential surface thereof, a tube formed of an unvulcanized unfoamed electrically conductive elastic layer material and a tube formed of a resistance adjusting layer material may be prepared. Then, the electrically conductive elastic layer tube and the resistance adjusting layer tube are fitted in this order around the metal shaft in a mold, and the respective layer materials are vulcanized and foamed. Thus, a roll having an electrically conductive elastic layer and a resistance adjusting layer provided around the metal shaft is produced. Thereafter, a protective layer is formed in the aforesaid manner on the outer circumferential surface of the roll.

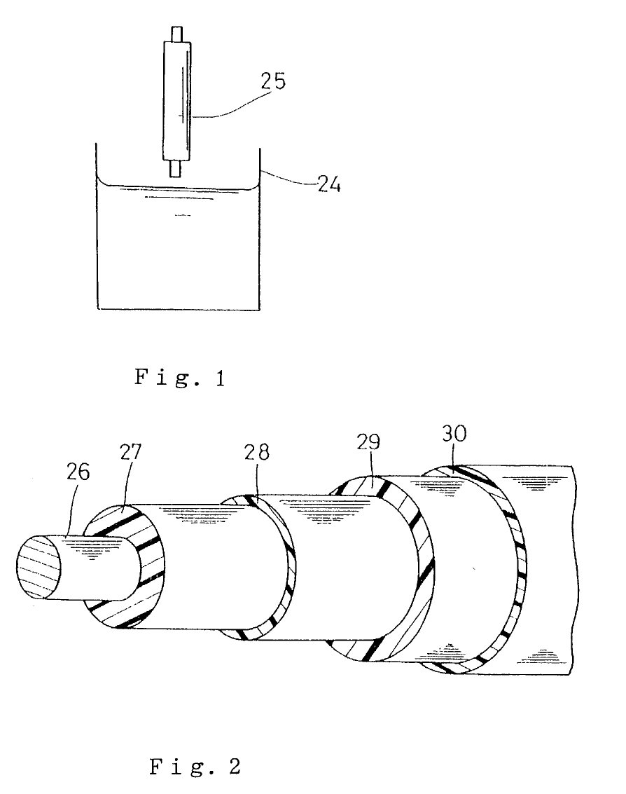

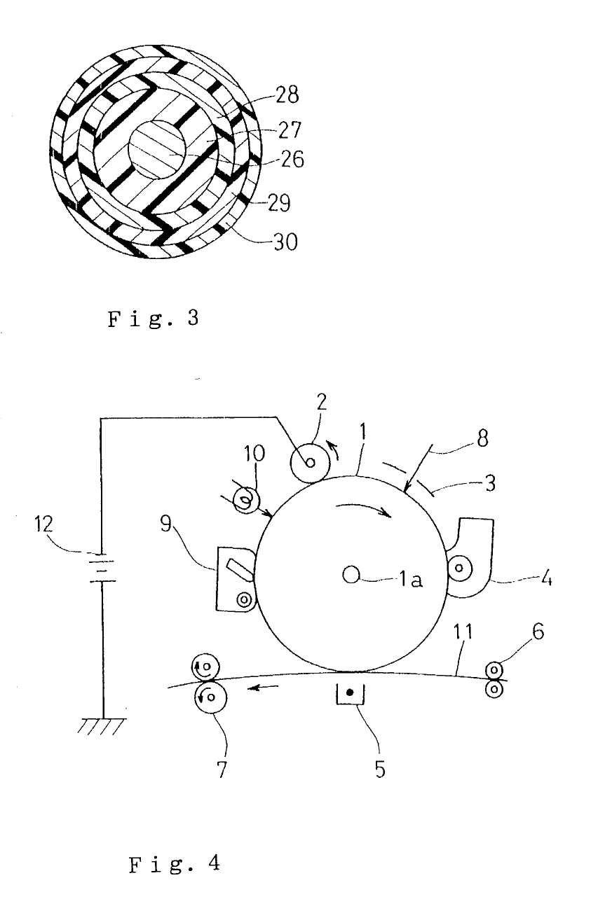

For the formation of the resistance adjusting layer, an unvulcanized rubber composition may be prepared by blending the ionic electrically conductive agent of the quaternary ammonium salt and, as required, other additives in the polar polymer (e.g., an epichlorohydrin-ethylene oxide copolymer rubber (ECO)), and kneading the resulting mixture by means of a mixer such as a kneader or a Banbury mixer. The unvulcanized rubber composition thus prepared is dissolved in a solvent for coating or, alternatively, extruded as it is by means of an extruder or the like. Where the formation of the resistance adjusting layer is achieved by the coating method, the unvulcanized rubber composition is dissolved in a proper solvent (e.g., methyl ethyl ketone or methyl isobutyl ketone), and the resulting solution is applied onto the outer circumferential surface of the electrically conductive elastic layer. Then, the resulting coating is dried, and heated for vulcanization of the rubber composition. The application of the coating solution may be achieved by a dipping method. More specifically, the solution containing the unvulcanized rubber composition is prepared as a dip solution in a bath 24 as shown in FIG. 1. Then, a roll 25 formed with an electrically conductive elastic layer is repeatedly dipped vertically in the dip solution for formation of an unvulcanized rubber layer on the outer circumferential surface of the electrically conductive elastic layer. The viscosity of the dip solution, dipping speed, the number of times of dipping and a drying period are preferably determined. The roll formed with the rubber layer is dried for removal of the solvent, and then heated for vulcanization of the rubber layer. Thus, the resistance adjusting layer is formed. Thereafter, the resistance adjusting layer is coated with a resin solution containing an N-methoxymethylated nylon and optionally an electrically conductive agent by a spraying method or a dipping method, followed by drying. As required, the resulting roll is subjected to a heat treatment for cross-linking. Thus, the protective layer is formed. In this manner, a charging roll having a construction as shown in FIGS. 2 and 3 is obtained. In FIGS. 2 and 3, the metal shaft is denoted by a reference numeral 26, and the electrically conductive elastic layer, the softener migration preventing layer, the resistance adjusting layer and the protective layer are denoted by reference numerals 27, 28, 29 and 30, respectively. In FIGS. 2 and 3, the electrically conductive elastic layer 27 may be formed of a foamed material. In this case, there is no need to provide the softener migration preventing layer 28.

In addition, the inventive charging member may be embodied as a charging blade.

Next, an explanation will be given to Examples and Comparative Examples.

### EXAMPLES 1 TO 6 AND COMPARATIVE EXAMPLES 1 TO 5

Preparation of Material for Electrically Conductive Elastic Layer

By blending the following components, a rubber composition was prepared as a material for forming an electrically conductive elastic layer.

| | |
|---|---|
| Polynorbornene rubber | 100 parts |
| Ketjen Black | 50 parts |
| Naphthenic oil | 400 parts |

Preparation of Material for Softener Migration Preventing Layer

By blending the following components, a carbon black dispersed resin liquid was prepared as a material for forming a softener migration preventing layer.

| | |
|---|---|
| N-methoxymethylated nylon | 100 parts |
| Carbon black | 15 parts |

Preparation of Materials for Resistance Adjusting Layers

By blending ingredients in accordance with formulations as shown in Tables 1 and 2 and kneading the resulting mixtures by means of a Banbury mixer, various unvulcanized rubber compositions were prepared as materials for forming resistance adjusting layers as identified as Examples 1 to 6 and Comparative Examples 1 to 5. More specifically, an equimolar copolymer of epichlorohydrin and ethylene oxide (ECO) was employed as a polar polymer, and red lead was employed as an acid receptor. Further, a thiourea cross-linking accelerator (SANCELER 22C available from Sanshin Chemical Industries) was employed as a cross-linking accelerator, and quaternary ammonium salts represented by the following formulae (3) to (7) were each employed as an ionic electrically conductive agent.

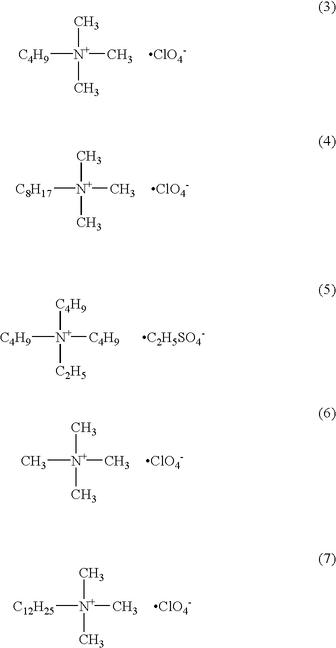

TABLE 1

| | | | | | | (parts) |
|---|---|---|---|---|---|---|
| | Example | | | | | |
| | 1 | 2 | 3 | 4 | 5 | 6 |
| Polar polymer | 100 | 100 | 100 | 100 | 100 | 100 |
| Acid receptor | 5 | 5 | 5 | 5 | 5 | 5 |
| Cross-linking | 1.5 | 1.5 | 1.5 | 1.5 | 1.5 | 1.5 |
| accelerator | | | | | | |
| Quaternary | 1 | 1 | 2.5 | 5 | 1 | 2.5 |
| ammonium salt | | | | | | |
| Type (formula) | (3) | (4) | (4) | (4) | (5) | (5) |

TABLE 2

(parts)

| | Comparative Example | | | | |
|---|---|---|---|---|---|
| | 1 | 2 | 3 | 4 | 5 |
| Polar polymer | 100 | 100 | 100 | 100 | 100 |
| Acid receptor | 5 | 5 | 5 | 5 | 5 |
| Cross-linking | 1.5 | 1.5 | 1.5 | 1.5 | 1.5 |
| accelerator | | | | | |
| Quaternary | 1 | 0.01 | 1 | 1.5 | 2.5 |
| ammonium salt | | | | | |
| Type (formula) | (6) | (7) | (7) | (7) | (7) |

Preparation of Material for Protective Layer

By blending the following components, a resin liquid was prepared as a material for forming a protective layer.

| | |
|---|---|
| N-methoxymethylated nylon | 100 parts |
| Carbon black | 8 parts |

Charging rolls of Examples 1 to 6 and Comparative Examples 1 to 5 were each produced in the following manner. First, an adhesive was applied on the outer circumferential surface of a metal core shaft having a diameter of 8 mm, and then an electrically conductive elastic layer having an outer diameter of 15 mm was formed around the metal shaft by vulcanizing the rubber composition as the electrically conductive elastic layer material in a mold. In turn, the carbon black dispersed resin liquid as the softener migration preventing layer material was sprayed on the outer circumferential surface of the electrically conductive elastic layer, and then the sprayed material was dried for formation of a softener migration preventing layer having a thickness of 6 μm to 10 μm. Each of the rubber compositions as the resistance adjusting layer materials was roll-kneaded, and then dissolved in a solvent mixture containing methyl ethyl ketone and methyl isobutyl ketone in a weight ratio of 3:1 for preparation of a dip solution having a viscosity of 0.5 Pa.s. The metal core shaft formed with the electrically conductive elastic layer and the softener migration preventing layer was dipped in the dip solution for coating thereof, and then the coating was dried and heated for cross-linking of the rubber composition. Thus, the resistance adjusting layer was formed on the softener migration preventing layer. Thereafter, the resin liquid as the protective layer material was sprayed on the outer circumferential surface of the resistance adjusting layer and the material was dried for formation of the protective layer. Thus, the intended charging roll was produced.

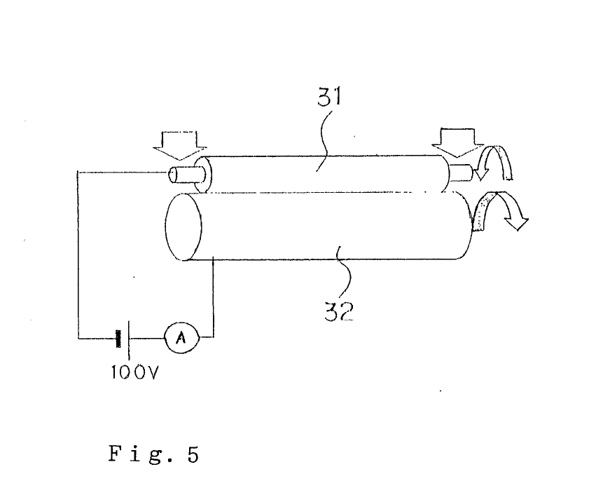

The electrical resistance of the charging roll thus produced was measured by a metal roll electrode method as shown in FIG. 5. More specifically, a load of 4.9 N was applied to opposite ends of the charging roll denoted by a reference numeral 31 to press the charging roll against a metal roll 32 having a diameter of 30 mm, and the metal roll was rotated at a rotation speed of 60 rpm in the direction of the arrow to cause the charging roll to rotate in contact with the metal roll 32. Then, a voltage of 100 V was applied to one end of the charging roll, and an electric current was measured for determination of an initial electrical resistance. After a lapse of 10 hours with the voltage kept applied in the state shown in FIG. 5, an electric current was measured for determination of an endurance electrical resistance. Then, an increase in electrical resistance was calculated on the basis of the electrical resistances thus determined. The results are shown in Tables 3 and 4.

After the charging roll was allowed to stand under high-temperature and high-humidity conditions (40 ° C., 95% RH) for one week and then under room-temperature and normal-humidity conditions (25° C., 50% RH) for one day, the surface of the charging roll was visually inspected. The results are shown in Tables 3 and 4, in which a symbol ◯ indicates that a blooming and bleeding phenomenon was not observed, and a symbol × indicates that the blooming and bleeding phenomenon was observed which would supposedly affect imaging.

TABLE 3

| | Example | | | | | |
|---|---|---|---|---|---|---|
| | 1 | 2 | 3 | 4 | 5 | 6 |
| Initial resistance (Ω) | 1.0 × 10⁷ | 9.1 × 10⁶ | 5.3 × 10⁶ | 3.2 × 10⁶ | 1.2 × 10⁷ | 7.0 × 10⁶ |
| Endurance | 3.0 × 10⁷ | 2.7 × 10⁷ | 1.0 × 10⁷ | 5.2 × 10⁶ | 3.0 × 10⁷ | 1.2 × 10⁷ |
| resistance (Ω) | | | | | | |
| Increase in resistance | 0.48 | 0.47 | 0.28 | 0.21 | 0.40 | 0.23 |
| (on logarithmic basis) | | | | | | |
| Blooming and bleeding | ◯ | ◯ | ◯ | ◯ | ◯ | ◯ |

TABLE 4

| | Comparative Example | | | | |
|---|---|---|---|---|---|
| | 1 | 2 | 3 | 4 | 5 |
| Initial resistance (Ω) | 5.0 × 10⁷ | 6.8 × 10⁷ | 9.8 × 10⁶ | 7.9 × 10⁶ | 6.0 × 10⁶ |
| Endurance | 2.0 × 10⁸ | 3.4 × 10⁸ | 3.8 × 10⁷ | 2.8 × 10⁷ | 1.5 × 10⁷ |
| resistance (Ω) | | | | | |
| Increase in resistance | 0.60 | 0.70 | 0.59 | 0.55 | 0.40 |
| (on logarithmic basis) | | | | | |
| Blooming and bleeding | X | ◯ | ◯ | X | X |

As can be understood from the results shown in Tables 3 and 4, the charging rolls of Examples 1 to 6 were each low in initial electrical resistance and endurance electrical resistance with a smaller increase in electrical resistance over time. In addition, the charging rolls of Examples 1 to 6 were free from the blooming and bleeding phenomenon, and had excellent properties.

As described above, the inventive charging member comprises the base material and the ionic electrically conductive agent of the quaternary ammonium salt represented by the general formula (1). Since at least one of the four alkyl groups bonded to the nitrogen atom of the quaternary ammonium salt is different from the other alkyl groups and at least one of the four alkyl groups is a C₄₋₈ alkyl group, the nitrogen atom at the center of the cation moiety has a greater charge amount. Thus, the charging member has a reduced electrical resistance as compared with a conventional charging member. Since the reduction in electrical resistance is achieved by the inclusion of a smaller amount of the quaternary ammonium salt, the charging member is free from bleed-out of the quaternary ammonium salt.

When one of R¹ to R⁴ in the general formula (1) representing the quaternary ammonium salt is a C₄-, C₆- or C₈-alkyl group and the other three of R¹ to R⁴ are each a methyl group or an ethyl group, the charge amount of the nitrogen atom can particularly be advantageously increased.

When three of R¹ to R⁴ in the general formula (1) representing the quaternary ammonium salt are each a C₄-, C₆- or C₈-alkyl group and the other of R¹ to R⁴ is a methyl group or an ethyl group, the charge amount of the nitrogen atom also can advantageously be increased.

When the quaternary ammonium salt represented by the general formula (1) is present in a predetermined proportion, the electrical resistance of the charging member easily can be reduced to a desired level, and bleed-out of the quaternary ammonium salt can be more effectively suppressed.

What is claimed is:

1. A charging member comprising a base material and an ionic electrically conductive agent of a quaternary ammonium salt represented by the following general formula (1): 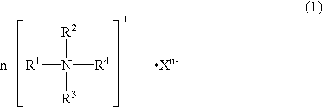
wherein R¹ to R⁴ are alkyl groups, at least one of which is a C₄₋₈ alkyl group and at least one of which is different from the at least one C₄₋₈ alkyl group, Xⁿ⁻is an n-valent anion, and n is an integer of 1 to 6.

2. A charging member as set forth in claim 1, wherein one of R¹ to R⁴ in the general formula (1) is a C₄-, C₆- or C₈-alkyl group and the other three of R¹ to R⁴ are each a methyl group or an ethyl group.

3. A charging member as set forth in claim 1, wherein three of R¹ to R⁴ in the general formula (1) are each a C₄-, C₆- or C₈-alkyl group, and the other of R¹ to R⁴ is a methyl group or an ethyl group.

4. A charging member as set forth in claim 1, further comprising an electron conductive agent.

5. A charging member as set forth in claim 1, wherein the base material is a polar polymer selected from the group consisting of epichlorohydrin-ethylene oxide copolymer rubbers, acrylonitrile-butadiene rubbers and urethane rubbers.

6. A charging member as set forth in claim 5, wherein the quaternary ammonium salt is present in a proportion of 0.05 to 5 parts by weight based on 100 parts by weight of the polar polymer.
